(19) United States
(12) Patent Application Publication
(10) Pub. No.: US 2003/0081578 A1
(43) Pub. Date: May 1, 2003

(54) Address allocation for mobile terminals

(76) Inventors: Douglas Andrew White, Gilbert, AZ (US); Cindy Jean Viola, Tempe, AZ (US); Nandakishore A. Albal, Scottsdale, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/014,273

(22) Filed: Oct. 26, 2001

(51) Int. Cl. H04Q 7/24

(52) U.S. Cl. 370/338; 370/395.53

(57) ABSTRACT

A method for an Internet Protocol (IP) address allocation by an external packet data network (40) to a mobile station (10) unburdens the mobile station (10) of directly contacting the external network. The mobile station requests (51) the unique IP address. The mobile network (31) statefully obtains the unique IP address from an external network (40). The mobile network (31) then transmit the verified, unambiguous unique IP address to the mobile station (10).

### BACKGROUND OF THE INVENTION

The present invention pertains to communication systems and more particularly to a method for allocating a unique interface identifier to a mobile station.

When a mobile station connects to a General Packet Radio Support (GPRS) or Universal Mobile Telecommunications Service (UMTS) network, the mobile station uses a PDP (packet data protocol) context activation procedure in order to establish an internet protocol connectivity with an external Packet Data Network (PDN). Present procedures for a mobile network (i.e. a GGSN, gateway GPRS support node) generate a unique mobile station interface identifier. This interface identifier is passed back to the mobile station during the PDP context activation.

However, this interface identifier does not allow the mobile station to generate an address with a network prefix other than the one from the GGSN. This mobile interface identifier may not be consistent with the other networks controlled by the mobile network. Mobile stations require access to other packet data networks for various data functions provided by 2G, 2.5G and 3G, etc. External packet data networks typically employ strict control mechanisms over address assignment.

Current procedures which allow a mobile station to access an external packet data network for an Internet Protocol Version 6 (IPv6) address require the mobile station to support separate stateful address autoconfigurations. The drawbacks of the current mobile station external PDN procedure are as follows. A mobile station must support an additional protocol such as DHCP (dynamic host configuration protocol) which adds to the complexity and cost of the mobile station. Since additional signaling is required over the air, the time between the request and the time the communication “payload” is actually transferred is increased; this is referred to as the post-dialing delay. Lastly, since the mobile station spends more time on the air, the power of the mobile station is not conserved.

It is therefore highly desirable to have a stateful autoconfiguration procedure performed by a mobile network instead of a mobile station which allows stateless autoconfiguration without requiring the mobile station to support DHCP or any other stateful address configuration protocol required by the external network.

### BRIEF DESCRIPTION OF THE DRAWING

FIG. 1 is a block diagram of an IP address allocation for mobile terminals in accordance with the present invention.

FIG. 2 is a message flow diagram of a procedure for allocation of IP address for mobile terminals in accordance with the present invention

### DETAILED DESCRIPTION OF THE PREFERRED EMBODIMENT

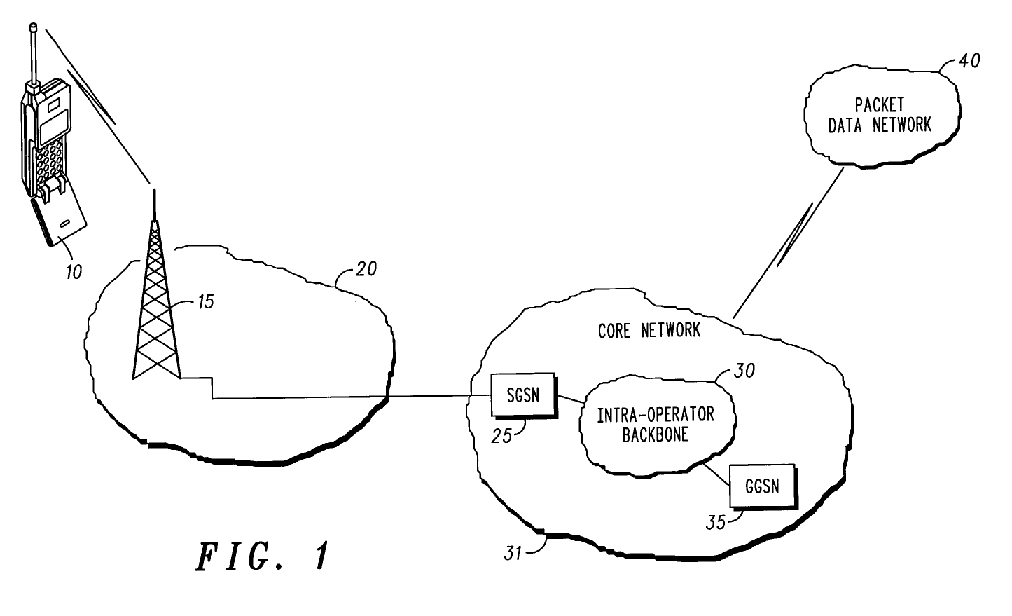

FIG. 1 is a block diagram of a mobile station access for internet protocol address allocation from an external packet data network 40. As mobile station is used herein, it includes a cellular telephone, personal digital assistant, computer laptop, pager or other “intelligent” device. Mobile station 10 is coupled to tower 15 of RAN 15 (radio access network). This coupling is in the form of an over-the-air cellular link in the example shown in FIG. 1, the link is a cellular one. Tower 15 and RAN 20 form the basis of the cellular network with which mobile station interfaces. Although a terrestrial cellular network is shown, a satellite communication network or other IPV6 network, such as a wireless LAN, is a suitable equivalent.

RAN 20 is coupled to SGSN (Signaling GPRS Support Node) 25 of core network 31. Either an intra-operator or inter-operator backbone 30 connects SGSN 25 to GGSN 35 (Gateway GPRS Support Node). GGSN 35 interfaces with the packet data network 40 in a stateful address autoconfiguration procedure to obtain an internet protocol version 6 address for mobile station 10. The internet protocol version 6 address is then relayed from packet data network 40 to GGSN 35 to mobile station 10.

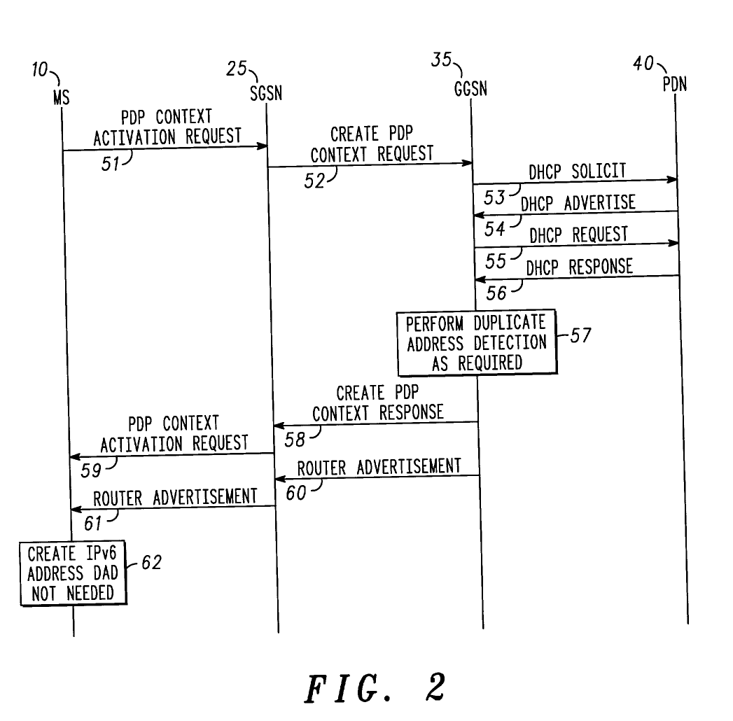

FIG. 2 is a message flow diagram of an IP address allocation method for mobile terminals. Mobile station 10 requests a packet data protocol (PDP) context activation request 51 to SGSN 25. The request is for connectivity between the mobile station 10 and an external packet data network 40. The SGSN (Serving GPRS Support Node) 25 forwards the request for connectivity 52 to GGSN (Gateway GPRS Support Node) 35. GGSN 35 examines the contents of the message. Based upon the message contents, the GGSN 35 determines that mobile station 10 needs an IPv6 address from the address space which is managed by the external packet data network 40.

The external PDN 40 requires the use of a stateful address autoconfiguration in order to obtain an IPv6 address. Acting on behalf of the mobile station 10, GGSN 35 solicits the address of a DHCP (Dynamic Host Configuration Protocol) server 41 within PDN 40 with the DHCP solicit message 53. PDN 40 responds to the request of GGSN 35 with a DHCP advertise message 54. The advertise message provides the address of the DHCP server 41 to be used by GGSN 35.

Responsive to the advertise message 54 from the external network, the GGSN sends a DHCP request message 55 to the DHCP server 41 of PDN 40 requesting an IPv6 address. Packet data network 40 then responds with an IPv6 address assigned to mobile station 10. Next, GGSN 35 performs a duplicate address detection (DAD) 57 procedure to validate the uniqueness of the IPv6 address.

When GGSN 35 determines the address to be unique the GGSN transmits the interface identifier portion of the IPv6 address back to the mobile station 10 through SGSN 25. GGSN 35 responds to the initial PDP context request 52 with a PDP context response message 58 which is transmitted to SGSN 25. SGSN then transmits a context activation response message 59 to the mobile station 10 via the radio access network (RAN) 20.

After sending the PDP context resonse message 58, the GGSN 35 also transmits a router advertisement message 60 to the SGSN 25. Router advertisement message 60 includes the network prefix obtained from the IPv6 address assigned to mobile station 10 by the external PDN 40. The mobile network comprising RAN 20, SGSN 25 and GGSN 35 does not manage or control this particular prefix.

Next, SGSN 25 transmits the router advertisement including PDN network prefix message 61 to mobile station 10. When mobile station 10 receives the router advertisement message 61 from SGSN 25, mobile station 10 performs a stateless autoconfiguration process. As a result, mobile station 10 creates the same IPv6 address as was assigned by PDN 40. Mobile station 10 created this same IPv6 address without the need for duplicate address detection, 62, since GGSN 35 has previously determined the uniqueness of the address. As a result, additional signaling over the air between the SGSN and mobile station 10 is alleviated.

This allocation address procedure has the benefit of requiring mobile station 10 to support only one method of obtaining an IPv6 address, regardless of the network which allocates the address. Mobile station 10 is not required to support an additional procedure for stateful address autoconfiguration such as DHCP. Further since the GGSN 35 performs the duplicate address detection process, the mobile device(s) 10 do not need to verify the uniqueness of the address and additional over the air signaling is saved as a result. Lastly, since the duplicate address detection procedures are not performed by the mobile device, there is no need to broadcast neighbor solicitation messages to other mobile stations in order to verify the uniqueness of the IPv6 address. As a result, the mobile device's design is much simpler and considerable over the air message transmission time is saved, thereby greatly increasing the battery life of the mobile station.

Although the preferred embodiment of the invention has been illustrated, and that form described in detail, it will be readily apparent to those skilled in the art that various modifications may be made therein without departing from the spirit of the present invention or from the scope of the appended claims.

1. A method for internet protocol (IP) address allocation comprising the step of:
requesting by a mobile station an activation for a unique IP address for an external network;
statefully obtaining by a network the unique IP address from the external network; and
transmitting the unique IP address by the network to the mobile station.

2. A method for IP address allocation as claimed in claim 1, wherein the step of statefully obtaining includes the step of soliciting by the network access to an address server within the external network.

3. A method for IP address allocation as claimed in claim 2, wherein the step of statefully obtaining further includes the step of sending by the address server an advertisement message to the network.

4. A method for IP address allocation as claimed in claim 3, wherein the step of statefully obtaining further includes the step of responsive to said advertisement message, requesting by the network the unique IP address via an address request message.

5. A method for IP address allocation as claimed in claim 4, wherein the step of statefully obtaining further includes the step of responsive to the address request message, assigning the unique IP address to the network for use by the mobile station.

6. A method for IP address allocation as claimed in claim 5, wherein there is further included a step of performing a duplicate address detection procedure by the network on the unique IP address to insure uniqueness of the unique IP address.

7. A method for IP address allocation as claimed in claim 6, wherein there is further included the step of sending by the network the unique IP address to the mobile station.

8. A method for IP address allocation as claimed in claim 7, wherein there is further included the step of sending by the network an address prefix of the external network to the mobile station.

9. In a mobile network, a method for obtaining an internet protocol (IP) address comprising the steps of:
requesting by a mobile station an activation for a unique IP address for an external network;
statefully obtaining by the mobile network the unique IP address from the external network; and
transmitting the unique IP address by the mobile network to the mobile station.

10. A method for IP address allocation as claimed in claim 9, wherein the step of statefully obtaining includes the step of soliciting by the mobile network access to an address server within the external network.

11. A method for IP address allocation as claimed in claim 10, wherein the step of statefully obtaining further includes the step of sending by the address server an advertisement message to the mobile network.

12. A method for IP address allocation as claimed in claim 11, wherein the step of statefully obtaining further includes the step of responsive to said advertisement message, requesting by the mobile network the unique IP address via an address request message.

13. A method for IP address allocation as claimed in claim 12, wherein the step of statefully obtaining further includes the step of responsive to the address request message, assigning the unique IP address to the mobile network for use by the mobile station.

14. A method for IP address allocation as claimed in claim 13, wherein there is further included the step of performing a duplicate address detection procedure by the mobile network on the unique IP address to insure uniqueness of the unique IP address.

15. A method for IP address allocation as claimed in claim 14, wherein there is further included the step of sending by the mobile network the unique IP address to the mobile station.

16. A method for IP address allocation as claimed in claim 15, wherein there is further included the step of sending by the mobile network an address prefix of the external network to the mobile station.

17. A network method for allocating a unique IP address comprising the steps of:
receiving a request for a unique IP address;
statefully obtaining the unique IP address from an external network; and
transmitting the unique IP address to a requester.

18. A method for IP address allocation as claimed in claim 17, wherein the step of statefully obtaining includes the step of soliciting by a network access to an address server within the external network.

19. A method for IP address allocation as claimed in claim 17, wherein the step of statefully obtaining further includes a step of requesting by the network the unique IP address via an address request message.

20. A method for IP address allocation as claimed in claim 18, wherein there is further included a step of performing a duplicate address detection procedure by the network on the unique IP address to insure uniqueness of the unique IP address.
